(19) United States
(12) Patent Application Publication
(10) Pub. No.: US 2026/0225751 A1
(43) Pub. Date: Aug. 6, 2026

(54) MACHINE AND PROCESS FOR FORMING LAYERS OF PRODUCTS

(71) Applicant: PLUSLINE S.R.L., Zola Predosa (IT)

(72) Inventors: Leonardo STAMATI, Milano (IT); Ezio SPENNATO, Bologna (IT)

(21) Appl. No.: 19/153,328

(22) PCT Filed: Mar. 15, 2024
(86) PCT No.: PCT/IT2024/050054

§ 371 Date: Aug. 3, 2025

(30) Foreign Application Priority Data
Apr. 7, 2023 (IT) 102023000006903

(51) Int. Cl. B65B 35/50; B65B 25/14; B65B 35/36; B65B 35/58

(52) U.S. Cl. CPC B65B 35/50; B65B 25/146; B65B 35/36; B65B 35/58; B65B 2210/02

(57) ABSTRACT

Bagging machine comprising bagging means (TS) which can be activated and deactivated and are configured to form, when activated, bags(S) containing a predetermined number of products (CP), wherein the bagging means comprise an entry side and an exit side for the products (CP) possibly contained in the bags(S). On said exit side there are gripping means (4) configured to engage the products (CP) or bags(S) and move them along a predetermined trajectory between said exit side and deposition area for. the products (CP) or bags(S) in which, by means of the same gripping means (4), layers of products (CP) or bags(S) are formed, each composed of a predetermined number of products (CP) or bags(S) which in turn are each arranged and oriented according to a predefined order by the gripping means (4).

The present invention concerns the packaging of products through the use of a bagging machine in which, if required, the bagging function can be deactivated. For example, the invention can be applied to the packaging of paper rolls, such as tissue paper rolls.

It is known that rolls of tissue paper, in particular rolls of toilet paper or “kitchen paper” are generally packaged by means of a packaging machine that produces packs or packages containing a predetermined number of rolls. The packages are transported to a bagging machine in which batches are formed, each consisting of a predefined number of packages and in which the batches are bagged to produce bags each of which contains a predefined number of said packages. For this purpose, the bagging machine has a tunnel, generally called welding tunnel, through which the products to be bagged and the film used to produce the bags pass. Downstream of the bagging machine there is generally a palletizing station in which robotic manipulators are installed which pick up the bags and arrange them on a pallet according to a predefined stratification order. In some processes, the bulk bagging phase can be avoided and, in this case, the batches pass through the machine's bagging station without being bagged and form a layer of batches intended to be placed on a pallet. This type of procedure is disclosed in EP1550610B1.

CH696535 describes a system for grouping and palletizing packs of products comprising a line that feeds the products, a final station of said line from which the grouped products exit, an elevator, a bagging machine, a conveyor, a robot and a palletizing station. The bagging machine produces bags containing possibly stacked products. The bags are then conveyed, via an exit conveyor, each oriented in the desired way, to a station where groups of bags are formed and where the robot operates. The robot palletizes groups of pre-oriented bags in the palletizing station. The system described in CH696535 requires excessive space compared to current production needs.

The main purpose of the present invention is to propose treatment and stratification methods that allow reducing the spaces required for the installation of the bag treatment and layering units.

A further aim of the present invention is to propose a bag treatment and layering system integrated into a bagging machine.

This result has been achieved, in accordance with the present invention, by providing a bagging machine and an operating process having the characteristics indicated in the independent claims. Other characteristics of the present invention are the subject of the dependent claims.

Thanks to the present invention, it is possible to reduce the overall dimensions and cost of bag treatment and layering systems, ensuring high operational flexibility for managing the palletization of bagged items according to methods programmable by the user. Moreover, it should be noted the construction simplicity of a machine in accordance with the present invention which, in addition, is equipped with mechanisms that allow the implementation of a process comprising operational phases capable of ensuring a high production and, at the same time, the integrity of the packages treated during the process.

These and further advantages and characteristics of the present invention will be more and better understood by every person skilled in the art thanks to the following description and the attached drawings, provided by way of example but not to be understood in a limiting sense, in which:

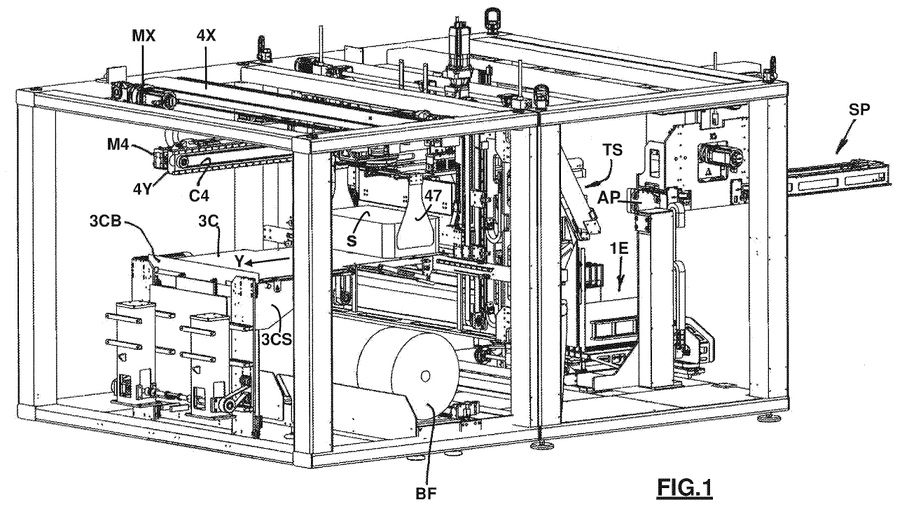

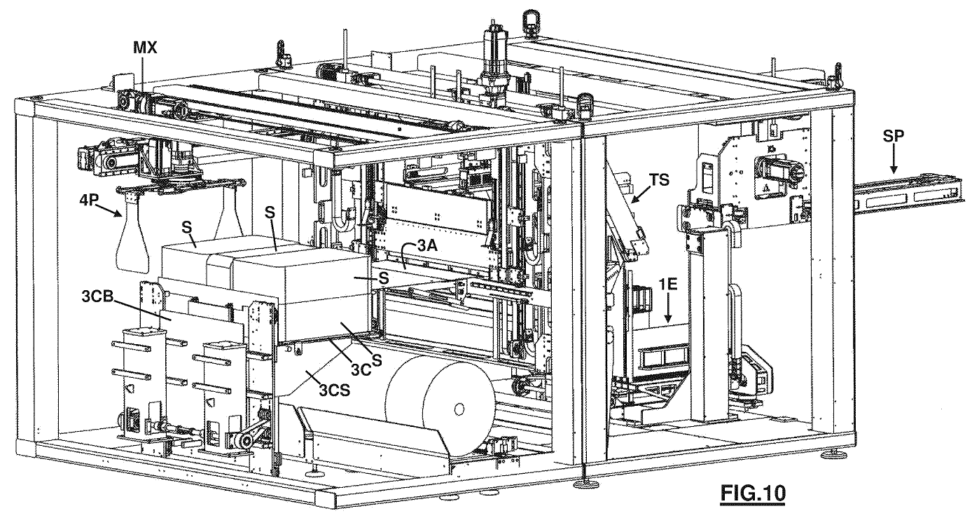

FIGS. 1-12 represent a perspective view of a bagging unit in accordance with the present invention in different operating phases;

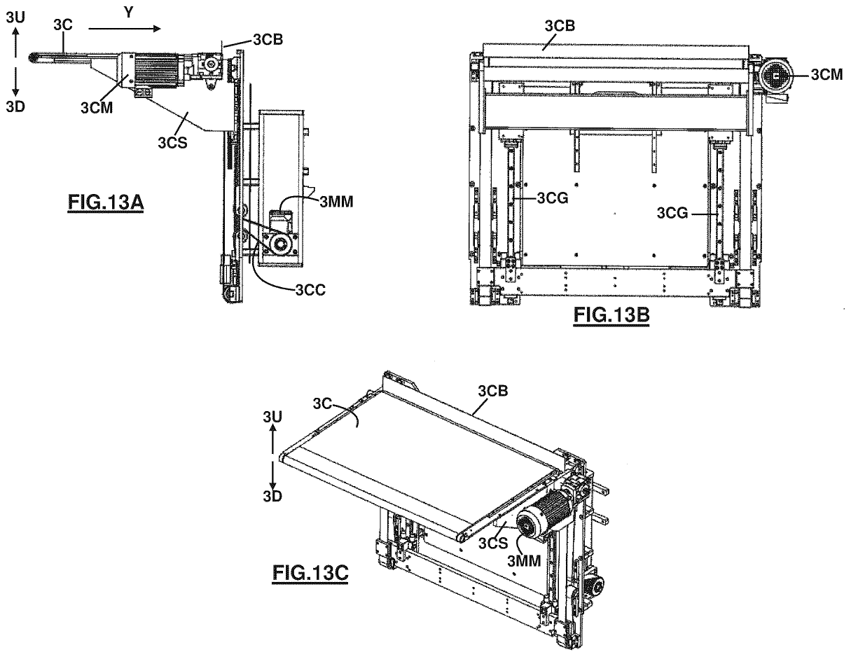

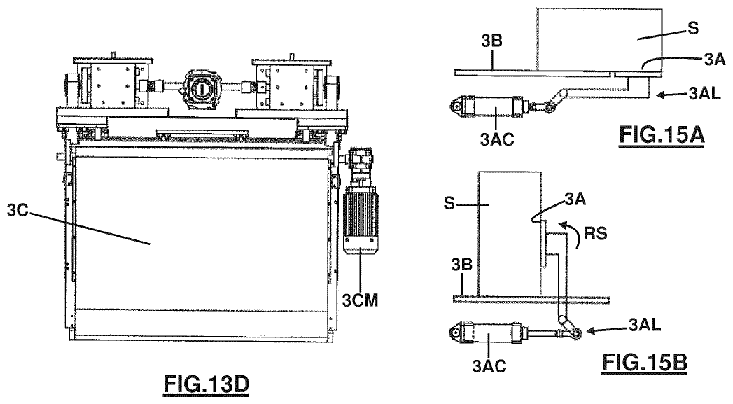

FIG. 13A represents a schematic side view of the layering device positioned downstream of the welding tunnel of the unit represented in FIGS. 1-12;

FIGS. 13B, 13C and 13D represent, respectively, a rear view, a perspective view and a top view of the device of FIG. 13A;

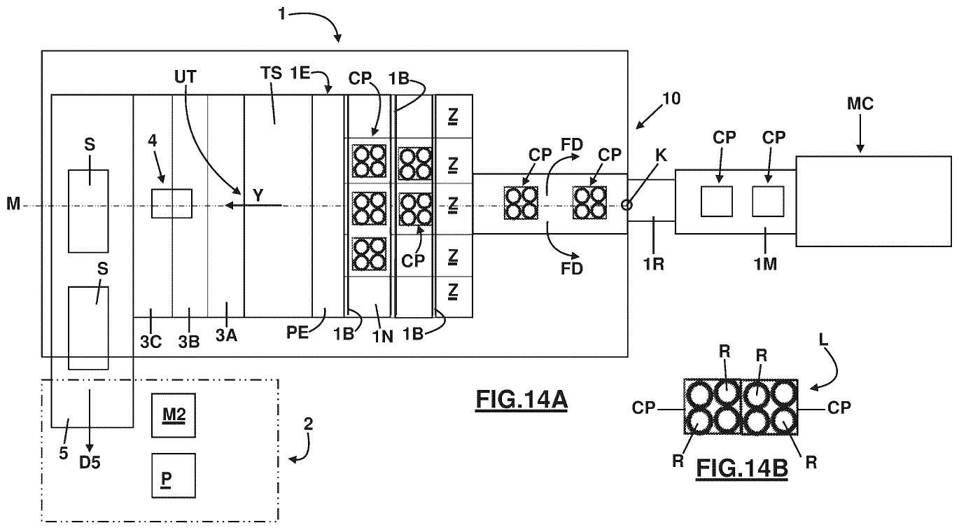

FIG. 14A is a diagram representing a possible way of using a machine in accordance with the present invention;

FIG. 14B schematically represents a batch made up of two packs of tissue paper rolls placed side by side;

FIGS. 15A and 15B schematically represent the rotation of a bag downstream of the bagging tunnel;

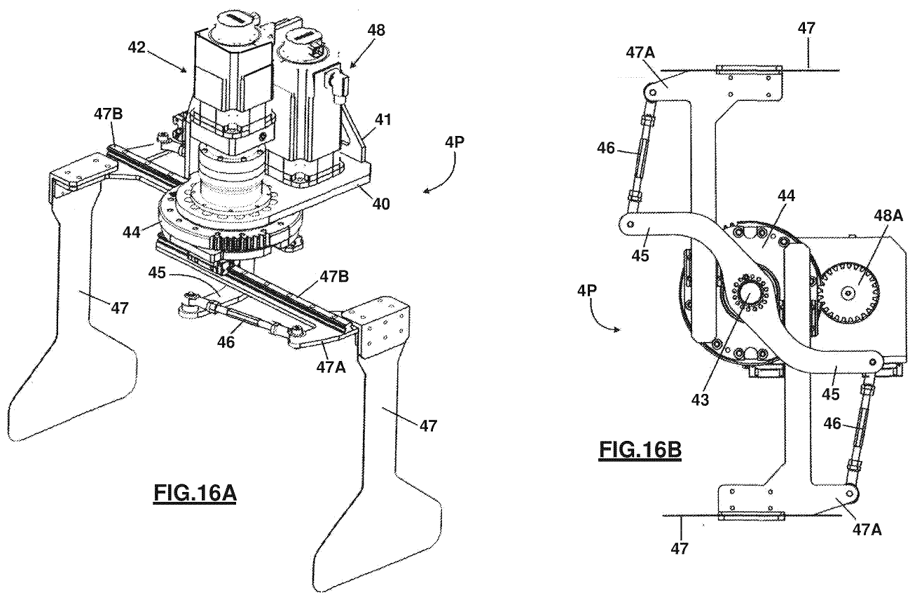

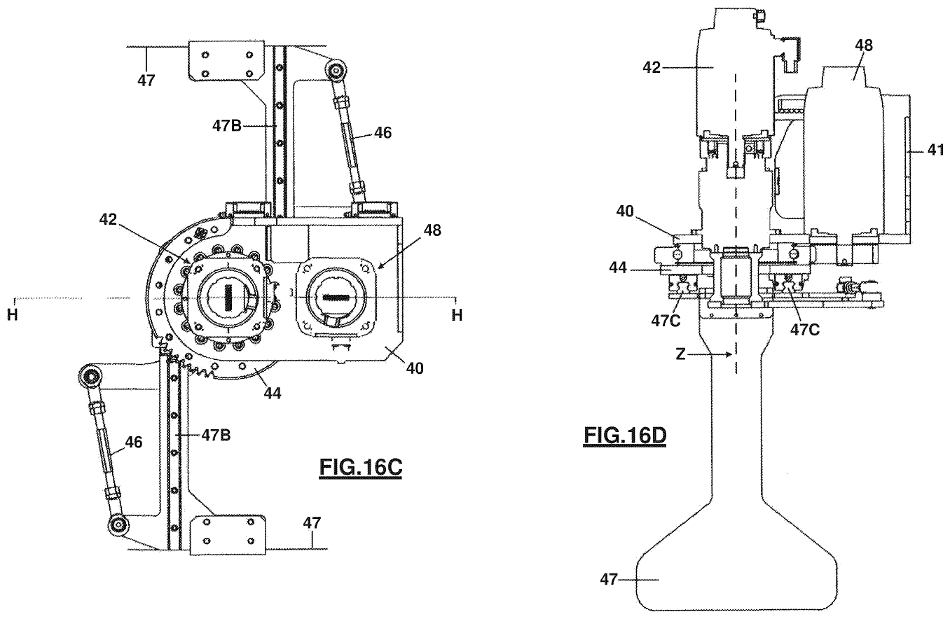

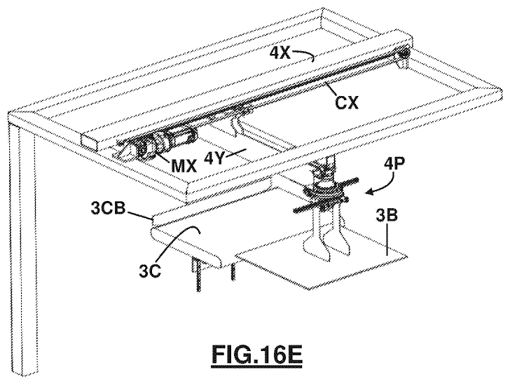

FIGS. 16A-16D represent a possible way of making a manipulator for handling bags in a perspective view (FIG. 16A), a view from below (FIG. 16B), a view from above (FIG. 16C) and a sectional view along the line H-H of FIG. 16C (FIG. 16D);-FIG. 16E represents a perspective view from above of the manipulator of FIGS. 16A-16D which Illustrates, in particular, the beams (4Y) and (4X).

Reduced to its essential structure and with reference to the attached exemplary drawings, a machine in accordance with the present invention can be configured to bag articles that can be packaged in a bag of plastic material.

The following description refers by way of example to the bagging of batches consisting of packs of tissue paper rolls such as toilet paper rolls. It is understood, however, that the processed products can be of any other type suitable to allow the use of the machine.

With reference to the attached exemplary drawings, a machine in accordance with the present invention comprises a batch forming and bagging section (1). Downstream of the machine, with respect to a direction (D5) along which the bags move away from the bagging machine, a palletizing section (2) is arranged. The batch formation and bagging section (1) has an entry station (10) which receives the packages (CP) of paper rolls produced by a packaging machine arranged upstream. The packaging machine is a machine known to those skilled in the art and is therefore not described in greater detail. In the exemplary diagram of FIG. 14A the packaging machine is indicated by the “MC” block. Each package (CP) is made up of a predetermined number of rolls of paper (R) arranged on a single layer or on multiple layers, wrapped by a wrapping sheet that, typically, consists of a film of plastic material.

Between the packaging machine (MC) and said inlet station (10) is arranged a respective conveyor (IM).

The packaging machine (MC) arranges the packages (CP) horizontally on the conveyor (IM), i.e. with the axes of the paper rolls arranged horizontally.

In the entry station (10) there is a tipping device (1R) which, with known methods, overturns the packages (CP), placing them in a vertical position.

The tipping device (1R) delivers the packages (CP) to a diverter (ID) which, in cooperation with a specific conveyor (IT), commonly called bar feeder, arranged downstream of the same diverter with respect to the direction of origin of the packages (CP), forms batches (L) each of which is made up of a predetermined number of packages (CP) placed side by side. In the exemplary diagram of FIG. 14B, a batch (L) is made up of two packs (CP) each containing four rolls (R). It is understood, however, that the number of packages that form the batches and
the number of rolls of each package may be different from what is exemplified. For example, a batch (L) could also consist of a single pack (CP) and a pack (CP) could also contain a single roll (R).

The bar feeder (IT) comprises a conveyor belt (IN) and a series of bar-shaped pushers (IB) oriented transversally to the conveyor belt. With known methods, the diverter (ID), rotating around a vertical axis (K) as schematically indicated by the arrows “FD” in FIG. 14A, places each package (CP) on a corresponding area (Z) of the bar feeder (IT) and the latter, thanks to the coordinated movement of the belt (IN) and the pushers (IB), transports the packages (CP) to an elevator (IE) on which, finally, the individual batches are arranged. The elevator (E) has a surface (PE) which receives the packages making up the individual batches and raises the batches to a height corresponding to the entrance of a tunnel (TS) in which means are arranged and acting for wrapping the batches in a bag(S) of plastic material and to seal the bag itself at the end of the bagging. In practice, the surface (PE) is positioned at the height of the tunnel (TS), after which a pusher (SP) intervenes which pushes the batch inside the tunnel (TS). The batches are bagged using methods known to technicians of this field. In the example of the attached drawings, the pusher (SP) has a front plate (AP), facing the tunnel (TS), which comes into contact with the batch to be inserted into the same tunnel. To carry out bagging, use is made of a film of plastic material fed by a reel (BF) placed underneath the tunnel (TS) to produce a tube which, following the entry of the products into the tunnel determined by the pusher (SP), is welded along its sides and at its tail side. A procedure of this type is described, for example, in EP1801012B1.

The coordinated intervention of the diverter (ID) and the bar feeder (IT) determines the formation of individual batches (L) according to the scheduled production. It goes without saying that the operation of the operative units described above is controlled by a programmable control unit in which the programmed production data are entered or stored. The operation and structure of the packaging machine (MC), the tipper (1R), the diverter (ID), the bar feeder (IT), the elevator (E), the pusher (SP) and the bagging tunnel (TS) are known to those skilled in the art.

In the bagging process, the batches (L) are pushed by the pusher (SP) onto a surface (3A, 3B, 3C) arranged downstream of the bagging tunnel (TS). Therefore, the bags containing the batches are on said surface (3A, 3B, 3C) which acts as a temporary support for the bags(S) in a position immediately downstream of the welding tunnel (TS). As further described below, the surface (3A, 3B, 3C) temporarily supporting the bags(S) is advantageously divided into several independent sections. Above the surface (3A, 3B, 3C) there are gripping means intended to engage the bags (S) exiting the welding tunnel (TS) and, as further described below, are used to form layers (LS) of bags in which each bag(S) has a predefined orientation depending on the programmed production. In the diagram of FIG. 14A the tunnel exit (TS) is Indicated by the reference “UT”.

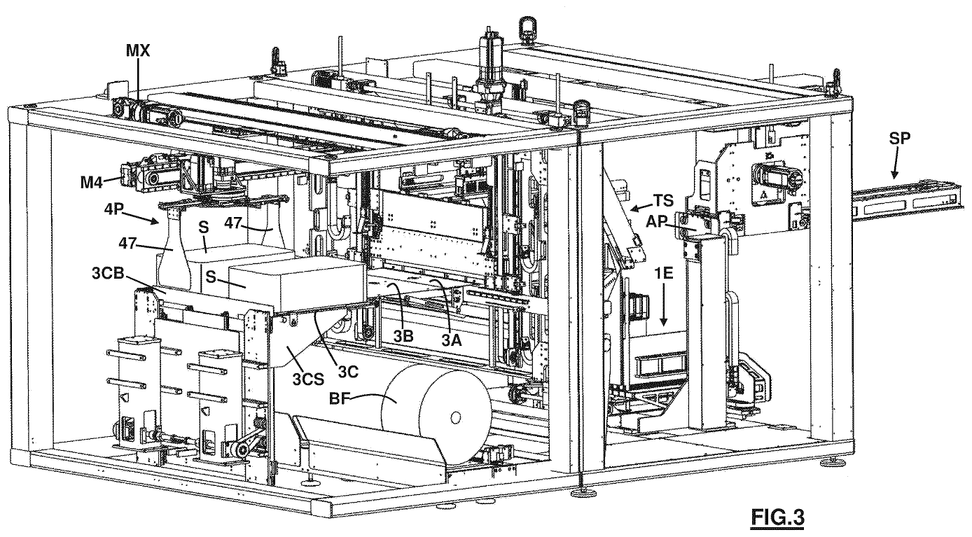

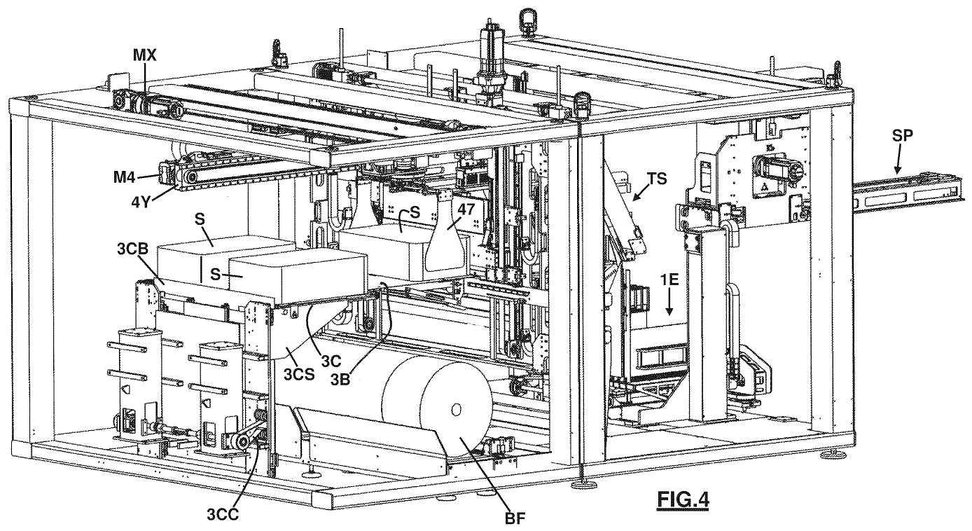

With reference to the example shown in FIGS. 3A-3B, said gripping means comprise a programmable manipulator (4) with a gripper (4P) having two jaws whose opening and closing movement is controlled according to the size of the batches progressively positioned on the surface (3). With reference to the examples shown in the attached drawings, the gripper (4P) is constrained to a corresponding beam (4Y) oriented parallel to the direction (Y) from which the bags(S) come out of the welding tunnel (TS), the gripper (4P) being connected to a belt (C4) driven by a respective gearmotor (M4) which controls its movement parallel to the beam (4Y). Said beam (4Y) is constrained, in turn, to a second beam (4X) fixed to the structure (SI) of the machine and oriented along the direction (X) orthogonal to the direction (Y) of origin of the bags (X), the beam (4Y) being connected to a belt (CX) driven by a respective gearmotor (MX) which controls its movement parallel to the beam (4X). Therefore, the gripper (4P) can be moved along both directions (X, Y). In other words, the gripper (4P) can be translated along both directions (X) and (Y) that are orthogonal to each other.

With reference to the example shown in FIGS. 16A-16D, the gripper (4P) comprises a base plate (40) with a rear orthogonal appendage (41) through which the gripper is connected to the belt (4C). On the upper side of the plate (40) a first electric motor (42) is mounted, whose shaft (43) passes through a toothed fifth wheel (44) with external teeth applied on the lower side of the plate (40). The toothed fifth wheel (44) is parallel to the plate (40) and has a rotation axis (Z) orthogonal to the same plate. A lever is mounted on the end of the shaft (43) of the motor (42) which defines two arms (45) in diametrically opposite positions. A rod (46) is mounted on each arm (45) which, on the opposite side, is applied to an appendix (47 A) of a linear slide (47B) on which a respective jaw (47) is mounted. Each slide (47B) is inserted into a corresponding guide (47C) formed on the lower side of the toothed fifth wheel (44). The latter is engaged, with its external teeth, with a pinion (48A) driven by a second electric motor (48) whose shaft passes through the plate (40) and is connected to the pinion (48A) which is also on the lower side of the plate (40). Therefore, the motor (42) controls the opening and closing, i.e. the mutual distancing and approaching, of the jaws (47) along the direction of the slides (47B), while the motor (48) controls the rotation of the toothed fifth wheel (44), and consequently of the jaws (47), around the aforementioned axis (Z).

Preferably, said jaws (47) are formed by shaped metal plates having a relatively reduced thickness.

Ultimately, the gripper (4P) can be moved along the (X) and (Y) directions and can rotate around the axis (Z) and the jaws (47) of the same gripper can be moved apart and closer to each other.

All the aforementioned actuators are controlled by the programmable control unit in which the programmed production data are entered or stored.

Preferably, in accordance with the present invention, the aforementioned temporary support surface (3) of the bags(S) is formed by several sections.

In particular, the surface (3) for temporarily supporting the bags(S) can be formed by two or more sections (3B, 3C; 3A) following one another along the direction (Y) of exit of the bags from the welding tunnel (TS) and one of them (3C), arranged in a position further downstream than the others (3B; 3A) with respect to said direction (Y), is connected to a mechanism that controls its descent and lifting so as to create a temporary support surface for the bags that can be positioned at different heights with respect to the exit of the welding tunnel (TS) depending on the process phase being executed. A description relating to a possible way of implementing such a system is provided below.

Said section (3C) of the surface (3) with the respective lifting and lowering mechanism constitutes a device useful for the layering of the bags(S), I.e. a device useful for the formation of several superimposed layers of bags(S), integrated in the bagging machine.

In the attached illustrative drawings, the temporary support surface (3) for the bags (S) is made up of three sections (3B, 3C, 3A) following one another along the direction (Y) of exit of the bags from the welding tunnel (TS): one of them (3C) is arranged in a position further downstream than the others (3B, 3A) with respect to said direction (Y), and is connected to a mechanism that controls its descent and lifting in order to create a temporary support surface for the bags that can be positioned at different heights with respect to the exit of the welding tunnel (TS); another section (3B) intermediate between the other two (3C, 3A) is fixed; and yet another section (3A) is provided in proximity of the exit of the welding tunnel and is a mobile surface. In particular, the mobile surface (3A) can be rotated from a horizontal position, in which it acts as a support for a bag at the exit of the welding tunnel, to a vertical position to determine the corresponding rotation of the bag whose orientation, therefore, switches from horizontal to vertical. In other words, the rotating section (3A) of said surface (3), if provided, can be used to overturn the bags coming out of the welding tunnel by rotating them 90° around a respective side as further described below. In the example shown in FIG. 15A and FIG. 15B, said mobile surface (3A) is served by a pneumatic actuator (3AC) which, using a suitable lever (3AL), controls its positioning in horizontal position (FIG. 15A) and respectively in vertical position (FIG. 15B). The arrow “RS” in FIG. 15B represents this movement of the surface (3A).

A possible cycle for layering the bags(S) on the aforementioned section (3C) is the following.

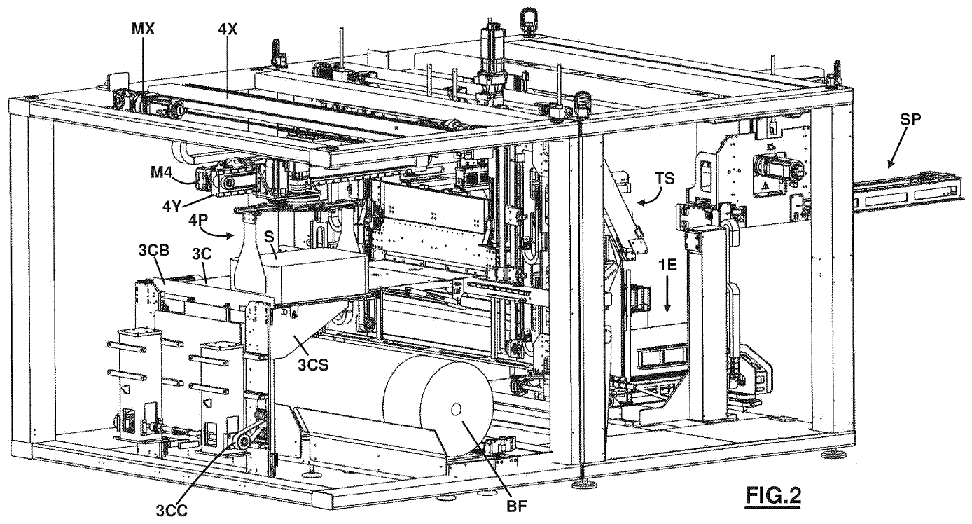

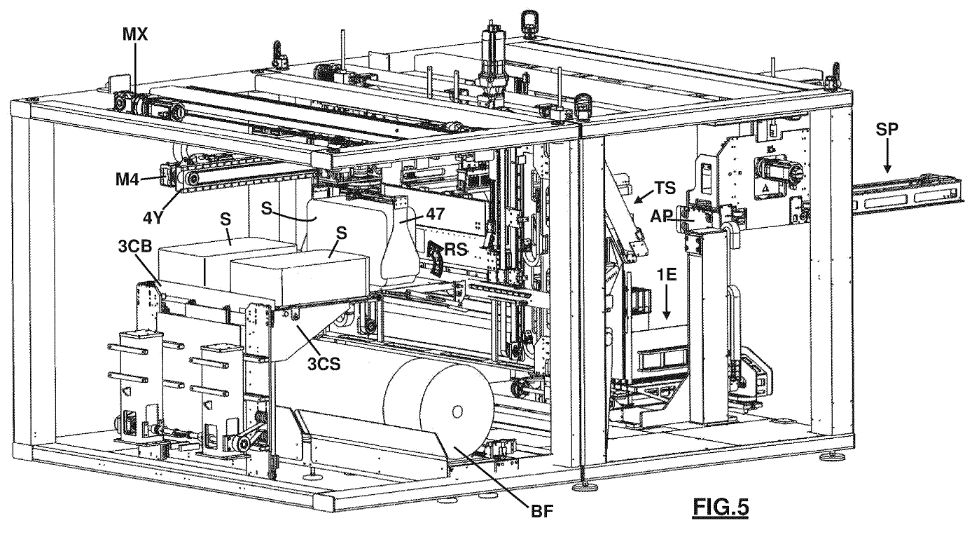

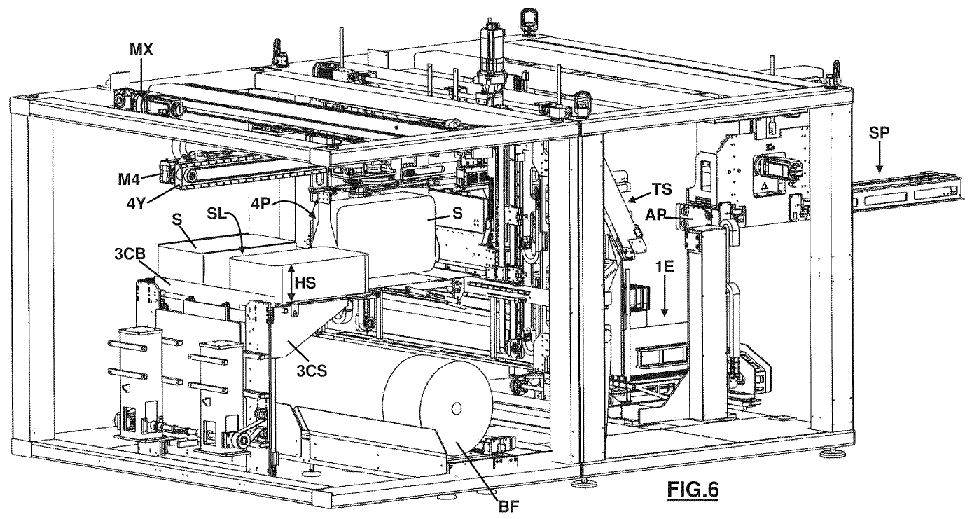

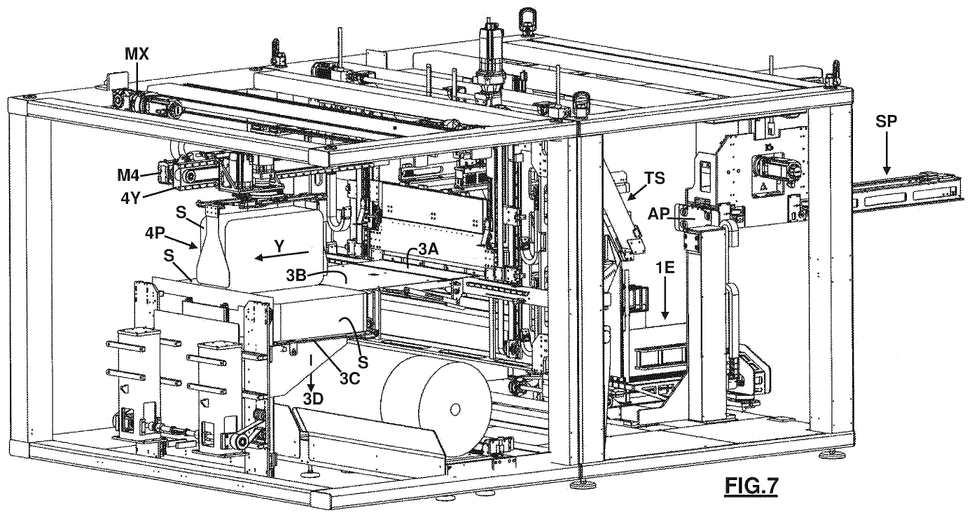

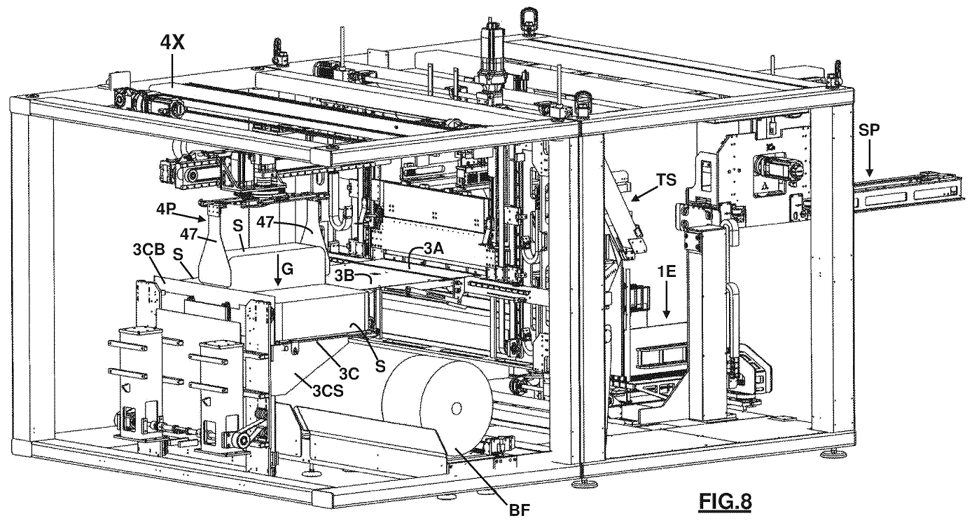

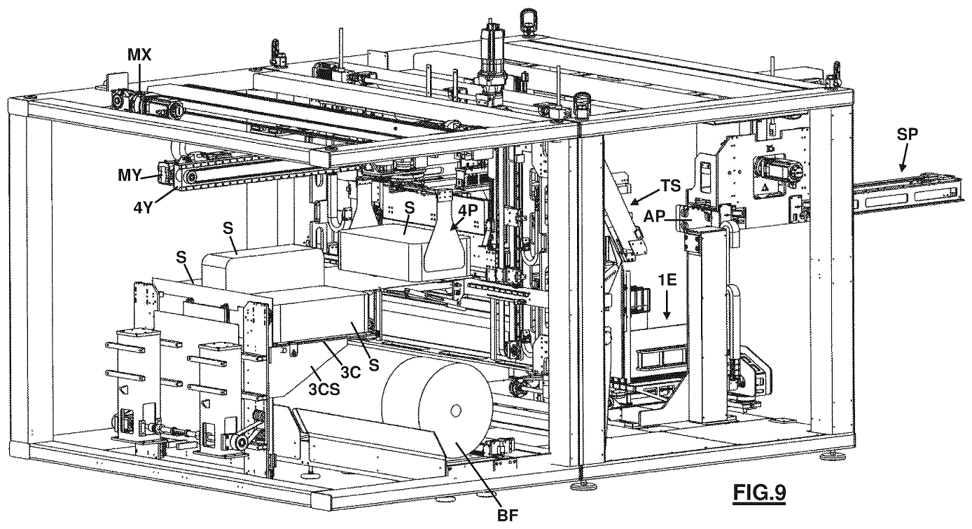

The gripper (4P) engages a bag(S) at the exit of the welding tunnel as in FIG. 1 and arranges it, oriented along a programmed direction (i.e. moving it parallel to itself or rotating it 90° clockwise or anti-clockwise as in FIG. 2) to release it on a pre-established area of the aforementioned section (3C). Subsequently, the gripper (4P) is brought back to the exit of the welding tunnel to engage a second bag that has been produced in the meantime and to place it, also oriented along a pre-established direction, on the aforementioned section (3C). In FIG. 3 the second bag is arranged with an orientation parallel to the bag previously transported on section (3C), i.e. both the first and second bags are oriented parallel to the direction (Y) on section (3C); in this example, the first and second bags are spaced apart by a pre-established value sufficient to form a space (SL) in which to insert a third bag as described below. Then, the gripper (4P) releases the second bag and is brought back to the exit of the welding tunnel to engage a third bag which has been produced in the meantime, as in FIG. 4. At this point, the section (3A) is rotated upwards and consequently the third bag is overturned by 90°, i.e. it rotates 90° around one of its sides so that the same bag passes from an initially horizontal position to a vertical position, as exemplified in FIG. 5 where the arrow “RS” represents said rotation. In this phase, the gripper (4P) does not hinder the aforementioned overturning but the jaws (47) constitute two guiding surfaces on two opposite sides of the bag which allow the overturning to be guided correctly, preventing the bag from moving laterally. The pressure exerted by the jaws (47) on the bags is contained within a range of relatively low values so as not to damage the film of which the bags are made or the products inside them. Subsequently, the gripper (4P) rotates 90° around its axis (Z) determining the corresponding rotation of the bag contained between the jaws (47), as shown by way of example in FIG. 6. Meanwhile, or immediately afterwards, the section (3C) is lowered by a value substantially corresponding to the height (HS) of the bags previously arranged on the same section, and the gripper (4P) transports the third bag onto the section (3C), placing it in the aforementioned space (SL) and releasing it, as exemplified in FIG. 7 and FIG. 8. The arrow “G” in FIG. 8 represents the descent by gravity of the third bag into space (SL). At this point, the gripper (4P) first picks up a fourth bag and then a fifth bag at the exit of the welding tunnel, placing them on the first bag and respectively on the second bag as previously described, as shown by way of example in FIGS. 9-11 . In this way, on the section (3C) a layering is formed, composed of two layers of superimposed bags, with four bags in a horizontal position and one bag in a vertical position between the other four. In practice, the jaws (47) of the gripper (4P) form, during the positioning of the third bag, two surfaces presented by the manipulator (4) which define a guided insertion channel of the third bag above the space (SL).

As described above, the operations of forming and superimposing the various layers are carried out by the gripping means (4) on said section (3C). In other words, the gripping means (4) and the product (CP) or bag(S) deposition area are arranged in the same station on the exit side of the bagging machine. Therefore, in this station the gripping means (4) provide both for the movement and orientation of the products (CP) or bags(S), and for the formation of said layers on the deposition area.

It goes without saying that the horizontal or vertical orientation of the individual bags and their position on the section (3C) may vary, compared to what has been previously described by way of example, depending on the planned production.

Depending on the desired configuration of the layers formed on section (3C), the section (3A) may not be a rotating section, or the section (3A) may not be rotated, so as to form a layering of bags without gaps between the bags of the individual layers and without bags arranged vertically.

The number of layers of bags on the section (3C) will depend on the number of lowering steps of the same section (3C) allowed by the space available below it and the dimensions of the bags.

Once the programmed layering is completed, the section (3C) is returned to its initial position and a new layering cycle is started with as described above.

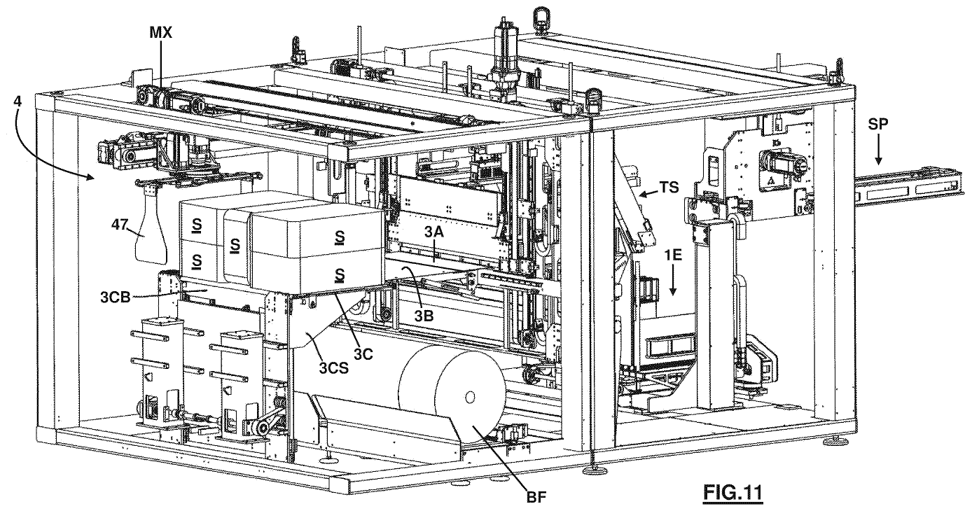

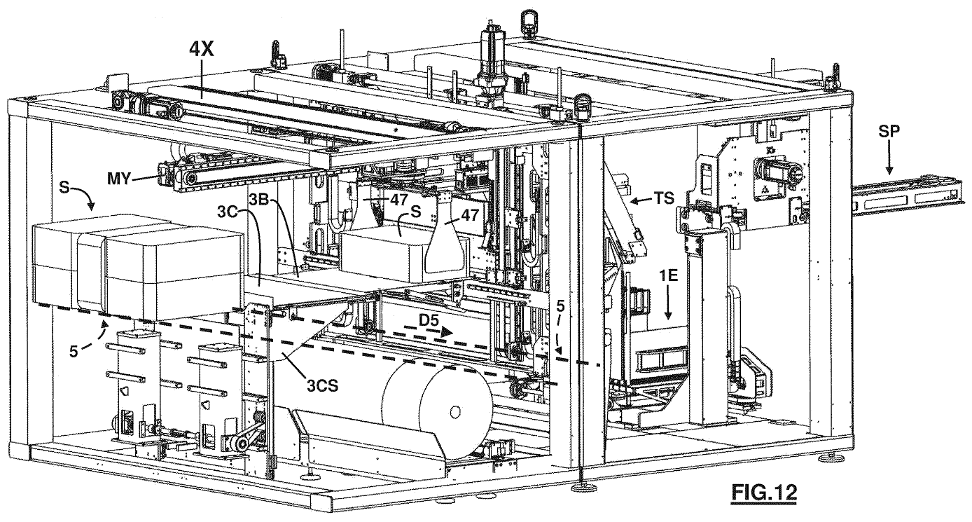

For example, the aforementioned section (3C) is made up of a belt closed in a ring on a respective support structure (3CS) and driven by a corresponding electric gearmotor (3CM). The structure (3CS) is in turn constrained to fixed vertical guides (3CG) on which it is moved by a second gearmotor (3MM) via a belt transmission (3CC). The double arrow (3U, 3D) in FIG. 13A and FIG. 13D represents the lifting (3U) and lowering (3D) of the section (3C). Since the belt that forms the section (3C) is oriented parallel to the direction (Y) of exit of the bags from the welding tunnel, i.e. it is wound on rollers (3CR) oriented orthogonally to said direction (Y), it also acts as a transporting belt for the layering formed on it. In particular, once the layering has been formed on said belt, the latter is activated to transfer the layering onto a conveyor (5) which in turn transports the layering to the palletizing section (2) in which the layerings are palletized. The conveyor (5) transports each layering to the palletizing section (2) where a second manipulator (M2) is positioned and acting, which picks up the layering and places it onto a pallet. This last operation can be performed with means and methods known to those skilled in the art and is therefore not described in greater detail. The conveyor (5) is represented schematically in FIG. 12 by dotted lines to better highlight other parts of the machine. The conveyor (5) is also represented in FIG. 14A. Preferably, a surface (3CB) is mounted on the structure (3CS) which, by means of a respective actuator (not visible in the drawings), is raised during the formation of the layers of bags, so as to form an abutment surface which reduces the risk of the bags falling from the surface (3C), and is lowered to allow the transfer of the layerings from the section (3C) to the conveyor belt (5). In FIGS. 1-10 the mobile stop surface (3CB) is raised while it is lowered in FIG. 11.

Said surface (3CB) is mounted on the back of the section (3C).

From the previous description it is evident that the layering of the bags(S) on the aforementioned section (3C) of the bagging machine derives from the provision of a system configured and controlled for carrying out the layering by transporting, following the formation of a first layer on the section (3C), the bags of the layers following the first one along respective deposition trajectories above the first layer in such a way that the bags of each layer are above the bags of an underlying layer. In the machine configured as previously described, this process is implemented through the controlled lowering of the section (3C) during the formation of the layers following the first layer. However, it is understood that, in accordance with the present invention, this process can be implemented differently, for example by connecting the manipulator (4) to a lifting mechanism which allows the bags(S) to be lifted to arrange them above the layers already formed without necessarily provide for the lowering of the section (3C), or by combining the lifting of the bags(S) by the manipulator (4) with the lowering of the section (3C).

From the previous description it is also evident that the layering of the bags(S) can be carried out providing a spacing between the bags of two adjacent layers to form a space (SL) in which it is possible to insert further bags positioned with orthogonal orientation in relation to the bags of said adjacent layers. During the transport of said further bags towards the space (SL), the manipulator (4) forms a guide which prevents their uncontrolled descent into the space (SL). In the example previously described, the guide that controls the descent of the further bags into the space (SL) is formed by the jaws (47) of the gripper (4P) which constitute, in this phase, two containment surfaces on two opposite vertical sides of the further bags.

A process in accordance with the example described above is a process for carrying out the layering of bags(S) each containing a predetermined number of products (CP), comprising a step of bagging the products (CP) using a bagging machine equipped with automatic bagging means with which said bags(S) are formed, a step of picking up the bags(S) on an exit side of the bags from said

bagging means by making use of an automatic manipulator (4), a subsequent transport step of the bags(S) up to a bags deposition area (3C) in which the manipulator (4) forms a layering composed of more layers of bags by depositing each bag in a respective pre-established position and oriented according to a direction which is also pre-established, the transport of the bags by means of the manipulator (4) being carried out along selectively predefined trajectories for each of the bags(S). As previously described, a process in accordance with the present invention entails that said gripping means (4) and the product (CP) or bags(S) deposition area are arranged in the same station on said exit side so that in this station said gripping means (4) ensure both the movement and orientation of the products (CP) or the bags (S) and the formation of said layers on said deposition area.

Preferably, the process provides that said deposition zone (3C) is a mobile surface served by movement means that control its descent, by a step of a value commensurate with the height of the bags, to lower said surface at the end of the formation of each layer of bags, for example along a vertical trajectory.

Said process can be implemented using a machine configured as previously described.

Preferably, said layering is carried out by forming a spacing between the bags of two adjacent layers to form a space (SL) in which further bags are inserted positioned with orthogonal orientation with respect to the bags of said adjacent layers and, in a step of releasing said further bags in the space (SL), the manipulator (4) guides the further bags along an insertion channel formed by surfaces (47) of the same manipulator.

The same layering procedure can also be implemented, with the machine described above, to form layers of non-bagged products. In this case the film is not unwound from the reel (BF) and the products, consisting of the packages (CP), pass through the tunnel (TS) without being bagged. In other words, the bagging function can be deactivated.

The products may also be unpackaged, i.e. not enclosed in a packaging wrap.

Therefore, in more general terms, a machine in accordance with the present invention is a machine comprising bagging means (TS; SP) which can be activated and deactivated and are configured to form, when activated, bags(S) containing a predetermined number of products (CP), in which the bagging means comprise an entry side and an exit side for the products (CP) possibly contained in the bags(S), wherein gripping means (4) are provided on said exit side and configured to engage the products (CP) or bags(S) and move them along a predetermined trajectory between said exit side and a deposition area for the products (CP) or bags(S) in which are formed, by means of the same gripping means (4), layers of products (CP) or bags (S) each composed of a predetermined number of products (CP) or bags(S) which in turn are arranged and oriented each according to a predefined order by the gripping means (4).

In practice, the gripping means (4) actively contribute to the formation of the layers since they are configured and controlled to move the products (CP) or the bags(S) and arrange them on the said deposition zone, each oriented according to a programmed orientation.

As previously highlighted, the “products” can be packages each containing a predetermined number of items enclosed in a wrapper or even individual packaged or unpackaged items and the product bagging means can be activated or deactivated depending on the scheduled production.

Therefore, the process previously described in relation to the treatment of bags(S) extends, in general, to the treatment of “products” which can be packages each containing a predetermined number of items enclosed in a wrapper or even individual packaged or unpackaged items and the product bagging step can be implemented or not implemented depending on the scheduled production.

If the products are not bagged, the gripping means (4) act directly on the products rather than on the bags(S).

From the previous description it is evident that a machine in accordance with the present invention is a bagging machine comprising bagging means (TS) which can be activated and deactivated and are configured to form, if activated, bags(S) containing a predetermined number of products (CP), wherein the bagging means comprise an entry side and an exit side for the products (CP) possibly contained in the bags(S), and in which gripping means (4) are provided on said exit side and. configured to engage the products (CP) or bags(S) and move them along a predetermined trajectory between said exit side and a deposition area of the products (CP) or bags (S) in which are formed, by means of the same gripping means (4), layers of products (CP) or bags(S) each composed of a predetermined number of products (CP) or bags (S) which in turn are arranged and oriented each according to a predefined order by the gripping means (4).

From the previous description it is also evident that a machine in accordance with the present invention can also exhibit one or more of the following further features, even combined with each other:
in the said area of deposition for the products (CP) or bags(S) a mobile surface (3C) is provided, on which the gripping means (4) deposit the products (CP) or bags(S) to form said layers, and which mobile surface (3C) is served by handling means that control its descent, by a step of a value commensurate with the height of the products (CP) or bags(S), to lower said surface (3C) at the end of the formation of each layer of products (CP) or bags(S).
said movement means control the descent of the mobile surface (3C) along a vertical trajectory.
said mobile surface (3C) is the terminal surface of a plurality of surfaces (3B, 3C; 3A, 3B, 3C) aligned along a direction (Y) of exit of the products (CP) or bags(S) downstream of the bagging means.
a surface (3 A) of said plurality of surfaces is connected to respective movement means which selectively control its rotation around a respective horizontal axis which is oriented orthogonally to said exit direction (Y).
said gripping means (4) comprise a manipulator (4) provided with a gripper (4P) with two jaws (47) with a first actuator (42) which controls the opening and closing of the jaws and a second actuator (48) which controls the rotation of the gripper around a respective vertical rotation axis (Z).
said deposition area (3C) is defined by a conveyor belt mounted on a structure (3CS) controlled by handling means that control its descent, by a step of a value commensurate with the height of the products (CP) or bags(S), to lower said surface (3C) at the end of the formation of each layer of products (CP) or bags(S).

A process has also been described for carrying out the layering of packaged or unpackaged products (CP) possibly inserted into bags(S) each containing a predetermined number of products (CP), comprising an optional step of bagging the products (CP) by means of a bagging machine equipped with bagging means that can be activated and deactivated with which said bags(S) can possibly be formed, a step of picking up the products (CP) or bags(S) on an exit side (CP) of said bagging means by respective gripping means (4), a subsequent step of transport of the products (CP) or bags(S) up to an area (3C) for deposition of the products (CP) or bags(S) in which the gripping means (4) form a layering composed of more layers of products (CP) or bags(S) placing each product or bag in a respective pre-established position and oriented according to a direction which is also pre-established, the transport of the products or bags by the gripping means (4) being carried out along selectively predefined trajectories for each of the products (CP) or bags(S), said gripping means (4) and the area (3C) for deposition of the products (CP) or bags(S) being arranged in the same station on said exit side such that in said station said gripping means (4) provide both for the movement and orientation of the products (CP) or bags(S), and for the formation of said layers on said deposition area.

The aforementioned process can also comprise one or more of the following additional features, even combined with each other:
said deposition area (3C) is a mobile surface served by handling means that control its descent, by a step of a value commensurate with the height of the products (CP) or bags(S), to lower said surface at the end of the formation of each layer of products or bags.
said movement means control the descent of the deposition zone (3C) along a vertical trajectory.
the process is implemented using a machine configured as previously described.
the bags(S) are made of a film of plastic material.
the products are packs of tissue paper rolls.
said layering is carried out by forming a spacing between the products or bags of two adjacent layers to form a space (SL) in which further products or bags are inserted positioned with orthogonal orientation with respect to the products or bags of said adjacent layers and, in a step for releasing said further products or bags into the space (SL), the gripping means (4) guide the further products or bags along an insertion channel formed by surfaces (47) provided by the same gripping means.

In practice, the execution details can however vary in an equivalent way as regards the individual elements described and illustrated, without thereby departing from the scope of the following claims.

1) Bagging machine comprising bagging means (TS) which can be activated and deactivated and are configured to form, if activated, bags(S) containing a predetermined number of products (CP), wherein the bagging means comprise an entry side and an exit side for the products (CP) possibly contained in the bags(S), characterized in that gripping means (4) are provided on said exit side and configured to engage the products (CP) or bags(S) and move them along a predetermined trajectory between said exit side and a deposition area of the products (CP) or bags (S) in which are formed, by means of the same gripping means (4), layers of products (CP) or bags(S) each composed of a predetermined number of products (CP) or bags (S) which in turn are arranged and oriented each according to a predefined order by the gripping means (4).

2) Bagging machine according to claim 1 characterized in that in said area of deposition for the products (CP) or bags(S) a mobile surface (3C) is provided, on which the gripping means (4) deposit the products (CP) or bags(S) to form said layers, and which mobile surface (3C) is served by handling means that control its descent, by a step of a value commensurate with the height of the products (CP) or bags(S), to lower said surface (3C) at the end of the formation of each layer of products (CP) or bags(S).

3) Bagging machine according to claim 2 characterized in that said handling means control the descent of the mobile surface (3C) along a vertical trajectory.

4) Bagging machine according to claim 2 characterized in that said mobile surface (3C) is the terminal surface of a plurality of surfaces (3B, 3C; 3A, 3B, 3C) aligned along a direction (Y) of exit of the products (CP) or bags(S) downstream of the bagging means.

5) Bagging machine according to claim 4 characterized in that a surface (3 A) of said plurality of surfaces is connected to respective handling means which selectively control its rotation around a respective horizontal axis which is oriented orthogonally to said exit direction (Y).

6) Bagging machine according to claim 1 characterized in that said gripping means (4) comprise a manipulator (4) provided with a gripper (4P) with two jaws (47) with a first actuator (42) which controls the opening and closing of the jaws and a second actuator (48) which controls the rotation of the gripper around a respective vertical rotation axis (Z).

7) Bagging machine according to claim 1 characterized in that said deposition area (3C) is defined by a conveyor belt mounted on a structure (3CS) controlled by handling means that control its descent, by a step of a value commensurate with the height of the products (CP) or bags(S), to lower said surface (3C) at the end of the formation of each layer of products (CP) or bags(S).

8) Process for layering packaged or unpackaged products (CP) possibly contained in bags(S) each containing a predetermined number of products (CP), comprising an optional step of bagging the products (CP) by means of a bagging machine equipped with bagging means that can be activated and deactivated with which said bags(S) can possibly be formed, a step of picking up the products (CP) or bags(S) on an exit side (CP) of said bagging means by respective gripping means (4), a subsequent step of transport of the products (CP) or bags(S) up to an area (3C) for deposition of the products (CP) or bags(S) in which the gripping means (4) form a layering composed of more layers of products (CP) or bags(S) placing each product or bag in a respective pre-established position and oriented according to a direction which is also pre-established, the transport of the products or bags by the gripping means (4) being carried out along selectively predefined trajectories for each of the products (CP) or bags(S), said gripping means (4) and the area (3C) for deposition of the products (CP) or bags(S) being arranged in the same station on said exit side such that in said station said gripping means (4) provide both for the movement and orientation of the products (CP) or bags(S), and for the formation of said layers on said deposition area.

9) Process according to claim 8 wherein said deposition area (3C) is a mobile surface served by handling means that control its descent, by a step of a value commensurate with the height of the products (CP) or bags(S), to lower said surface at the end of the formation of each layer of products or bags.

10) Process according to claim 8 wherein said handling means control the descent of the deposition zone (3C) along a vertical trajectory.

11) Process according to claim 8 characterized in that it is implemented using a bagging machine comprising bagging means (TS) which can be activated and deactivated and are configured to form, if activated, bags(S) containing a predetermined number of products (CP), wherein the bagging means comprise an entry side and an exit side for the products (CP) possibly contained in the bags(S), wherein the gripping means (4) are provided on said exit side and configured to engage the products (CP) or bags(S) and move them along a predetermined trajectory between said exit side and a deposition area of the products (CP) or bags (S) in which are formed, by means of the same gripping means (4), layers of products (CP) or bags(S) each composed of a predetermined number of products (CP) or bags (S) which in turn are arranged and oriented each according to a predefined order by the gripping means (4).

12) Process according to claim 8 characterized in that the bags(S) are made of a film of plastic material.

13) Process according to claim 8 characterized in that the products are packs of tissue paper rolls.

14) Process according to claim 8 characterized in that said layering is carried out by forming a spacing between the products or bags of two adjacent layers to form a space (SL) in which further products or bags are inserted positioned with orthogonal orientation with respect to the products or bags of said adjacent layers and, in a step for releasing said further products or bags into the space (SL), the gripping means (4) guide the further products or bags along an insertion channel formed by surfaces (47) provided by the same gripping means.
